(19) United States
(12) Patent Application Publication
(10) Pub. No.: US 2010/0060636 A1
(43) Pub. Date: Mar. 11, 2010

(54) METHOD AND DEVICES FOR MODELING TEMPLATES OR STENCILS FOR THREE-DIMENSIONAL OBJECTS WITH NON-DEVELOPABLE SURFACES AND FOR ASSISTING THE TRANSFER OF TWO-DIMENSIONAL MOTIFS ONTO THOSE OBJECTS

(75) Inventors: Francis Saraille, Merville (FR); Henri Jeannin, Plaisance Du Touch (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Airbus Operations, Toulouse (FR)

(21) Appl. No.: 12/597,359

(22) PCT Filed: Apr. 23, 2008
(86) PCT No.: PCT/FR08/00582

§ 371 Date: Oct. 23, 2009

(30) Foreign Application Priority Data
Apr. 26, 2007 (FR) 0754720

(51) Int. Cl. G06T 17/00

(52) U.S. Cl. 345/420

(57) ABSTRACT

The purpose of the method and the devices of the present invention is to assist the transfer of two-dimensional patterns onto three-dimensional objects having non developable surfaces using a modelling (305) of said three-dimensional object and a projection of said two-dimensional pattern onto said modelling of said three-dimensional object. A first phase comprises modelling at least a portion of said modelling of said three-dimensional object through a plurality of developable surfaces (310). The second phase comprises transferring at least a portion of said projection of said two-dimensional pattern on at least one developable surface of the plurality of developable surfaces, said plurality of developable surfaces being adapted to be positioned on said three-dimensional object for transferring said two-dimensional pattern.

The present invention relates to the decoration of three-dimensional objects and more particularly to methods and devices for modeling precuts or pounce patterns for three-dimensional objects with non-developable surfaces and for assisting in the transfer of two-dimensional patterns onto these objects.

Projection of a two-dimensional image onto a three-dimensional object is commonly used in numerous industries for decorating these objects. The complexity of this problem varies according to the nature of the three-dimensional object and the nature of the projection surface. Thus, although the projection of a two-dimensional image onto a continuous surface of small dimensions, such as the external surface of a beverage can, does not pose any particular problem, the projection of a logo, symbol or name onto the external surface of an airplane poses numerous problems. In particular, the task is made difficult by the complexity of the shape of the projection surface, the scaling factor between the reproduced image and the original image, as well as the presence of certain particular elements on which certain parts, such as the cabin windows, of the two-dimensional image to be reproduced must be painted or not painted.

The general purpose of decorating airplanes is to apply the commercial image of the airline companies, and it often comprises painting names, signs and logos that must be performed flawlessly. The adaptation of the model of the airline company to the particular shapes of each airplane is generally based on experience and on an empirical analysis. The validation of this adaptation is often associated with the construction of mockups.

When the projection of the two-dimensional pattern onto the three-dimensional object is determined, it is then necessary to transfer this projection onto the real object. Several solutions exist.

European Patent EP 0593340 discloses a method and a device for assisting in decorating a three-dimensional object. The method consists in representing a three-dimensional model of the decorated object by a tracing of the decoration. It then consists in locating, on the object, on the basis of the 3D model, at least certain characteristic points of the said tracing, in order to position, for example, adhesive tape for outlining the decoration, or stencils or precut decorative elements, etc. This invention is also applicable in particular to decorating an airplane by distinctive logos, letters or signs on the external surface of this aircraft.

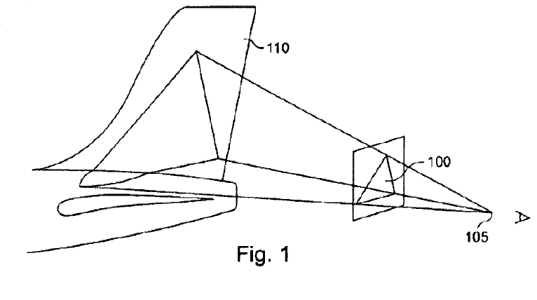

FIG. 1 illustrates an example of conic projection for reproducing a two-dimensional image on the external surface of an airplane. The projection of image 100 from projection point 105 onto the vertical tail assembly of an airplane 110 reveals problems related to conic projection onto a tapered part of the external surface of an airplane, such as the junction between the vertical tail assembly and the fuselage. In addition, such a method is not easy to employ.

Alternatively, it is possible to use stencils, which may be positioned by using certain reference points of the airplane, such as the positions of the cabin windows. However, because of the complex shape of the surface of the airplane, the stencils generally have non-developable shape, meaning that these stencils cannot assume a planar shape. This results in considerable difficulties and design, manufacturing and storage costs. In addition, the stencils are generally difficult to position, and it is often necessary to use reference points specific for this purpose.

A need therefore exists for efficiently transferring two-dimensional patterns onto three-dimensional objects having a complex surface.

The invention makes it possible to solve at least one of the problems discussed in the foregoing.

The object of the invention is therefore a method for modeling precuts or pounce patterns for at least part of a three-dimensional object with a non-developable surface from a modeling of the said three-dimensional object, this method comprising the following steps,
breaking down the said at least one part of the said three-dimensional object into a plurality of surfaces; and
for each surface of the said plurality of surfaces, approximating the said surface of the said modeling of the said three-dimensional object by a developable surface.

In this way the method according to the invention makes it possible to obtain precuts and pounce patterns easily at low costs. The method according to the invention also makes it possible to preserve a model of precuts and pounce patterns that can be used subsequently and/or for the transfer of different patterns.

According to a particular embodiment, the method additionally comprises a step of measuring at least one error between at least one of the said developable surfaces of the said three-dimensional object and the said model of the said three-dimensional object and in that the said steps of breaking down the said at least one part of the said three-dimensional object into a plurality of surfaces and of approximating the said surfaces of the said modeling of the said three-dimensional object by the said developable surfaces are repeated if the said at least one measured error is larger than a predetermined threshold. According to this embodiment, it is possible to check the precision of adjustment of precuts and pounce patterns on the three-dimensional model.

Advantageously, the said modeling of the said three-dimensional object is an approximate modeling of the said three-dimensional object, the said modeling taking into account the error introduced by the modeling of the three-dimensional object as developable surfaces.

According to another particular embodiment, the said step of approximating a surface of the said part of the said modeling of the said three-dimensional object by a developable surface comprises a step of determining a first and a second reference curve on the said modeling of the said three-dimensional object, the said developable surface being the constrained surface determined by the said first and second reference curves.

At least one of the said first and second reference curves can be obtained by the intersection of a surface of the said modeling of the said three-dimensional object with a predetermined plane. Alternatively, or in complementary manner, at least one of the said first and second reference curves is determined by a characteristic of a two-dimensional pattern to be projected onto the said three-dimensional object. The said first and second reference curves may be parallel.

According to a particular embodiment, the method additionally comprises a step of transferring at least one characteristic point of the said modeling of the said three-dimensional object onto at least one of the said developable surfaces. In this way the positioning precision permits a faithful reproduction of the pattern of a three-dimensional model on the real three-dimensional object, especially in the zones of complex surfaces.

Another object of the invention is a method for assisting in the transfer of a two-dimensional pattern onto a three-dimensional object with a non-developable surface, from a modeling of the said three-dimensional object and a projection of the said two-dimensional pattern onto the said modeling of the said three-dimensional object, this method being characterized in that it comprises the following steps,
modeling precuts or pounce patterns for at least one part of the said modeling of the said three-dimensional object by a plurality of developable surfaces according to the method described in the foregoing; and
transferring at least part of the said projection of the said two-dimensional pattern onto at least one of the said developable surfaces, the said at least one of the said developable surfaces being adapted to be positioned on the said three-dimensional object in order to transfer at least part of the said two-dimensional pattern onto the said three-dimensional object.

In this way the method according to the invention makes it possible to simplify the process of transferring a two-dimensional model onto a three-dimensional object and to reduce the risks of errors in positioning of precuts or pounce patterns. In addition, the method according to the invention makes it possible to dispense with a validation step, according to which the construction of a real mockup is necessary.

Another object of the invention is a device comprising means adapted to employing each of the steps of the method described in the foregoing as well as a computer program comprising instructions adapted to employing each of the steps of the method described in the foregoing.

Other advantages, objectives and characteristics of the present invention become evident from the detailed description provided hereinafter by way of a non-limitative example, referring to the attached drawings, wherein:

FIG. 1 illustrates an example of a conic projection making it possible to reproduce a two-dimensional image on the external surface of an airplane;

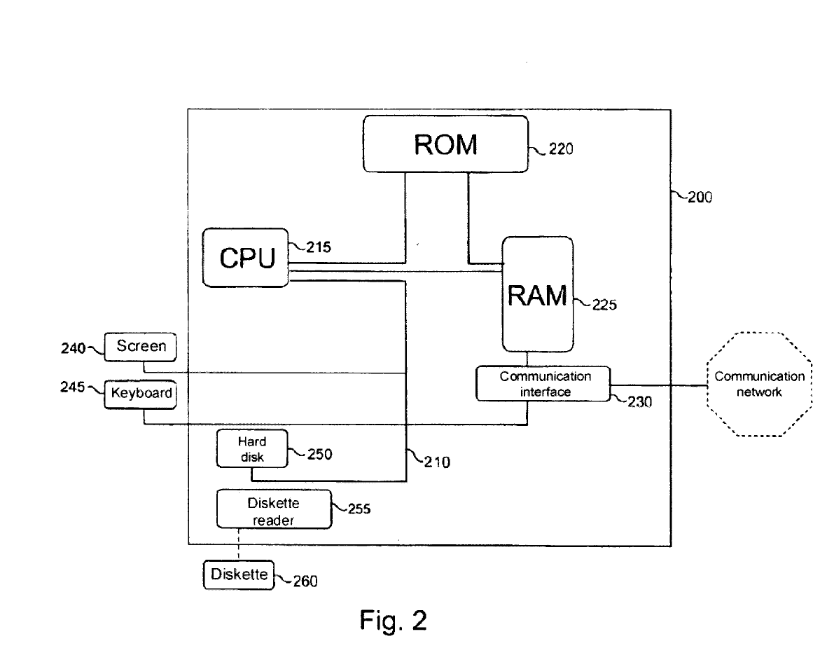

FIG. 2 shows an example of an apparatus making it possible to implement the invention;

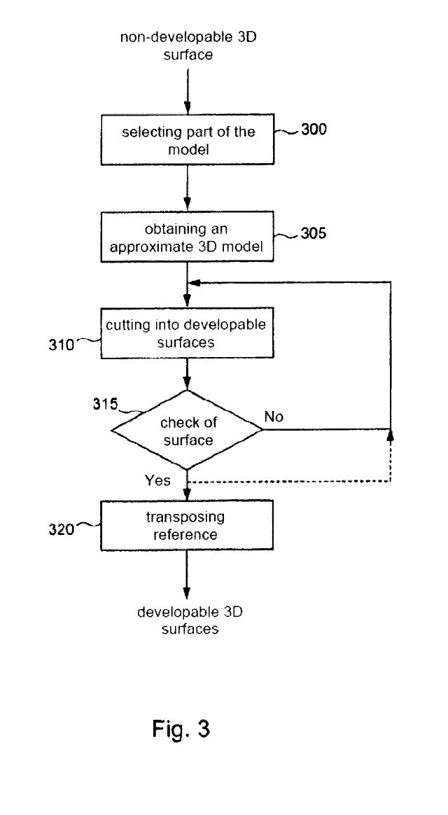

FIG. 3 illustrates certain steps of an example of an algorithm for employing a first part of the method according to the invention in order to model the three-dimensional object by a set of developable surfaces;

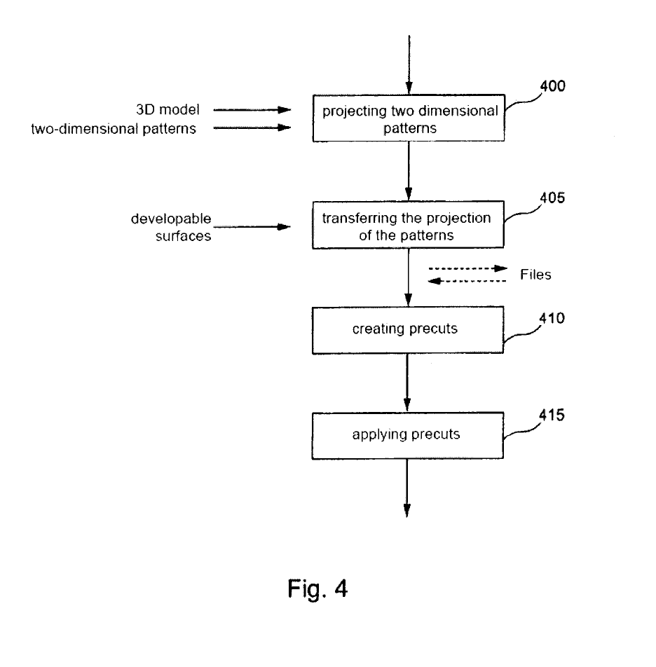

FIG. 4 illustrates certain steps of an example of an algorithm for obtaining a set of precuts or pounce patterns from a model of a three-dimensional object composed of developable surfaces and a two-dimensional pattern; and

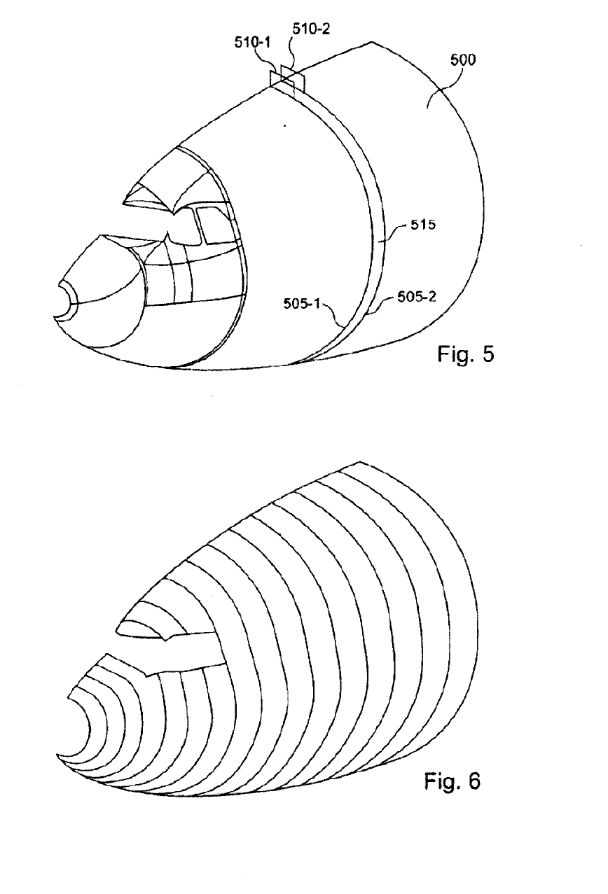

FIGS. 5 to 8 represent illustrations of certain of the steps presented in FIGS. 3 and 4.

The following description is based on the example of the external decoration of an airplane, but it should be understood that the method and the devices according to the invention are applicable to decorating all three-dimensional objects on the basis of a two-dimensional representation of the decoration.

FIG. 2 illustrates an example of an apparatus 200 adapted to employing the invention. As an example, apparatus 200 is a microcomputer or a workstation that may or may not be capable of being connected to a communication network. Apparatus 200 is provided with a communication bus 210, to which there are preferably connected:
a central processing unit 215, such as a microprocessor denoted by CPU (Central Processing Unit);
a read-only memory 220, which may contain programs for employing the invention, denoted by ROM (Read Only Memory);
a random-access memory 225, which after boot-up contains the executable code of the method according to the invention as well as registers capable of recording variables and parameters necessary for employing the invention, denoted by RAM (Random Access Memory); and,
a communication interface 230 connected to a communication network, the interface being capable of transmitting and receiving data.

Optionally, apparatus 200 may also be provided with the following components:
a screen 240 for viewing data and/or for functioning as a graphical interface with the user who will be able to interact with the programs according to the invention, with the aid of a keyboard 245, which may or may not be supplemented by another means, such as a pointing device, for example a mouse, a light pen or even a touch screen;
a hard disk 250 or a storage memory such as a compact flash card, which may contain the programs according to the invention as well as data used or produced during employment of the invention; and,
a diskette reader 255 (or any other removable data medium) capable of receiving a diskette 260 and therein reading or writing data processed or to be processed according to the invention.

The communication bus permits communication and interoperability between the different elements included in apparatus 200 or connected thereto. The representation of the bus is not limitative and, in particular, the central unit is capable of communicating instructions to any element of apparatus 200 directly or by way of another element of apparatus 200.

Diskettes 260 may be replaced by any information medium such as, for example, a compact disk (CD ROM), which may or may not be rewritable, a ZIP disk or a memory card, and in general by an information storage means that may be read by a microcomputer or a microprocessor, which may or may not be integrated in the apparatus, which may be removable and capable of storing in memory one or more programs whose execution permits employment of the method according to the invention.

The executable code permitting the apparatus to employ the invention may be stored equally well in read-only memory 220, on hard disk 250 or on a removable digital medium such as, for example, a diskette 260 as described in the foregoing. According to one variant, it will be possible for the executable code of the programs to be received by way of the communication network, via interface 230, to be stored in one of the storage means of apparatus 200, such as hard disk 250, before being executed.

Central unit 215 is capable of commanding and directing the execution of instructions or portions of software code of the program or programs according to the invention, such instructions being stored in one of the aforesaid storage means. During boot-up, the program or programs stored in a non-volatile memory, for example on hard disk 250 or read-only memory 220, are transferred into random-access memory 225, which then contains the executable code of the program or programs according to the invention as well as registers for storing in memory the variables and parameters necessary for employment of the invention.

It should be noted that the apparatus containing the device according to the invention may also be a programmed apparatus. This apparatus then contains the code of the computer program or programs for example resident in an integrated circuit for specific applications (Application Specific Integrated Circuit or ASIC).

The method according to the invention can be broken down into two phases. The object of a first phase is to model the three-dimensional object by a set of developable surfaces, or in other words three-dimensional surfaces that can be represented in a plane, without deformation. The object of a second phase is to transfer the two-dimensional pattern onto the modeled developable surfaces.

The first phase has to be performed only once for each model of a three-dimensional object, whereas the second phase must be repeated one or more times for each two-dimensional pattern (for each color, for example) to be transferred onto this three-dimensional object, and for each three-dimensional object.

FIG. 3 illustrates certain steps of an example of an algorithm for employing the first part of the method according to the invention in order to model the three-dimensional object by a set of developable surfaces. Once a three-dimensional model of the object to be modeled has been created, a first step consists in determining the part to be modeled (step 300), in this case meaning the part onto which the two-dimensional pattern is to be transferred. The three-dimensional model of the object is obtained, for example, from a computer assisted design software program (CAD), such as Catia (Catia is a trademark), was developed by Dassault Systèmes and sold by International Business Machines Corporation. This step may take the symmetry of the three-dimensional object into account. Thus, for example, for an airplane onto which a two-dimensional pattern is to be transferred, it is possible to select only part of the airplane along a longitudinal section determined according to the median vertical plane, as illustrated in FIG. 5. It is also possible to break down the modeling of a three-dimensional object into surfaces that can be developed in several parts, each part being related to the complexity of the surface associated with it.

When the part of the three-dimensional model is selected, a new surface, known as the modeling surface, is determined to obtain an approximate three-dimensional model (step 305). The modeling surface is used instead of the surface of the three-dimensional object to be modeled, in order to allow for the error introduced by the modeling of the three-dimensional object as developable surfaces, or in other words to allow for the difference in length between the theoretical starting surface and the developable surface. The modeling surface is a surface parallel to the surface of the three-dimensional object, and is situated on the exterior of the three-dimensional object. The distance between the modeling surface and the real surface of the three-dimensional object is chosen as a function of the type of three-dimensional object to be modeled. In particular, if the three-dimensional object to be modeled is an airplane, the distance between the modeling surface and the real surface of the airplane is chosen according to the type of airplane, the type and number of panel junctions and the position of the theoretical airplane profile. For example, for an Airbus A320 airplane, the distance chosen is 2 mm and, for an Airbus A340 airplane, the distance chosen is 3.5 mm. However, since the method is preferably iterative, this distance can be determined automatically.

When the modeling surface is determined, a set of developable surfaces is determined starting from the modeling surface (step 310). Each developable surface is determined by two reference curves of the modeling surface, the developable surface being constructed by the set of segments normal to the two curves and the ends of which belong to the two curves, forming a constrained surface. More generally, the developable surfaces can be constructed by any type of scan that fits a segment onto one or more curves. In particular, the reference curves of the modeling surface can be determined by the intersection of planes with the modeling surface or by the shape of the two-dimensional pattern to be projected itself. For example, FIG. 5 illustrates a modeling surface 500 comprising two curves 505-1 and 505-2 obtained by the intersection of parallel planes 510-1 and 510-2 with modeling surface 500. The developable surface generated by curves 505-1 and 505-2 is surface 515. It should be noted to note here that the distance between the reference curves is preferably determined according to the complexity of the surface to be modeled. According to an advantageous embodiment, there is used a default distance between two neighboring reference curves, this distance being reduced recursively as long as the difference between the modeling surface and the developable surface generated by these two reference curves is larger than a predetermined threshold (step 315). In this way, if the distance between the modeling surface and the developable surface generated by the two reference curves being used is larger than a predetermined threshold, the distance between the two reference curves being used is reduced and a new developable surface is calculated (step 310 is repeated).

The maximum difference between the modeling surface and the developable surface must be at most 2 mm in this case. Of course, this value can be reduced or increased to improve or lessen the precision.

On the other hand, if the distance between the modeling surface and the developable surface generated by the two reference curves being used is smaller than a predetermined threshold, and if the modeling surface has not yet been entirely modeled by developable surfaces, two new reference curves are selected, or only one if the second corresponds to the preceding selection, in order to determine a new developable surface. As represented by the dashed arrow, the process is repeated until the entire selected surface is modeled by developable surfaces.

Alternatively, the distance between two reference curves may be regular and predetermined.

By way of illustration, the developable surfaces presented in FIGS. 5 to 8 were generated starting from reference curves resulting from the intersection of vertical planes perpendicular to the longitudinal axis of the airplane. These planes are parallel in this case, and they generate developable surfaces in the form of bands.

When the set of developable surfaces of the selected part of the three-dimensional object has been created, it is possible to model other non-selected parts by using certain symmetries. For example, the modeling of the half airplane cockpit presented in FIG. 6 may be used to model the entirety of the airplane cockpit as developable surfaces. Such an extension is achieved by simple geometry.

It is then advantageous to transpose certain characteristic points of the three-dimensional object onto the developable surfaces in order to facilitate subsequent positioning of precuts or pounce patterns on the three-dimensional object (step 320). In particular, characteristic curves such as the outlines of panels constituting the airplane, the contours of cabin windows and the contours of doors are projected onto each developable surface. Such a projection is achieved according to traditional methods, such as the method presented in the patent cited in the foregoing.

The result obtained by the algorithm presented in FIG. 3 is therefore a set of developable surfaces, preferably comprising characteristic points. This set of developable surfaces may be used directly to transfer the two-dimensional pattern or may be stored in the form of an electronic file to be used subsequently or to be used subsequently for the transfer of other two-dimensional patterns. When the set of developable surfaces is stored in memory in the form of an electronic file, such a file may contain, for example, the set of contours of these developable surfaces, with which there are advantageously associated their respective position as well as lists of characteristic points. The developable surfaces may be stored in memory in the form of three-dimensional surfaces or in the form of planar surfaces, that is, the developable surfaces are developed according to a standard geometric transformation.

FIG. 4 illustrates certain steps of an example of an algorithm for obtaining a set of precuts or pounce patterns starting from a model of a three-dimensional object composed of developable surfaces and of a two-dimensional pattern.

The model of the three-dimensional object is used to project the two-dimensional patterns (step 400) according to a standard projection algorithm, such as that presented in the patent cited in the foregoing. The projection of the three-dimensional patterns is then transferred onto the developable surfaces (step 405) in the same way as the characteristic points of the three-dimensional object were transferred onto the developable surfaces (step 320 of FIG. 3).

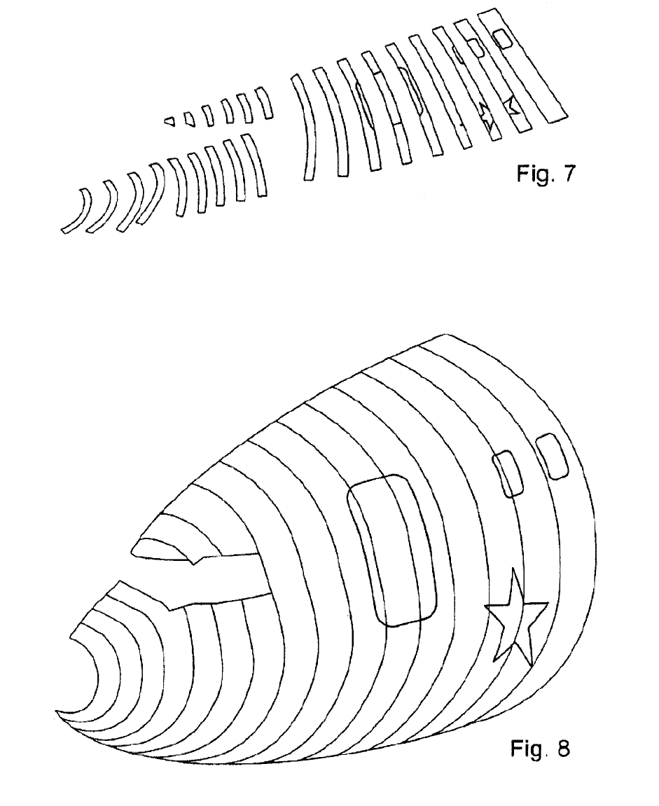

The developable surfaces are then preferably developed and positioned in a given plane to facilitate the creation of files of outlines that may be used to produce precuts or pounce patterns. FIG. 7 represents a set of developable and developed surfaces comprising characteristic points and the projection of two-dimensional patterns. The creation of such files constitutes an effective means of transmitting the precise and final data pertaining to each developable surface to a manufacturer of precuts or pounce patterns. Such files also make it possible to preserve a representation of precuts or pounce patterns for subsequent direct use, such as repainting the decorations of an airplane.

Starting from previously determined information items, it is possible to manufacture the precuts or the pounce patterns (step 410). The formats of the precuts or pounce patterns are determined according to the two-dimensional patterns to be reproduced and according to characteristic references that permit positioning of the precuts or pounce patterns. According to a particular embodiment, the manufacture of precuts or pounce patterns preferably comprises the following steps,
tracing contours of developable and developed surfaces on a substrate for precuts or pounce patterns;
cutting out developed surfaces with the aid of the previously traced contours; and
tracing, on the developed and cut-out surfaces, characteristic points used for positioning precuts or pounce patterns on the three-dimensional object and patterns.

The manufacture of pounce patterns and precuts is advantageously achieved on machines capable of tracing and cutting out adhesives, such as adhesive or Mylar precuts, or any other substrate suitable for assuring tracing or masking on the three-dimensional object.

Application onto the three-dimensional object is then achieved according to a previously defined schedule, in order to follow a logical and organized sequence, without resorting to supplementary aids such as datum points or other reference marks. Depending on the zone of the airplane, the schedule is preferably established according to the number and type of references permitting positioning of precuts or pounce patterns. It should be noted that a precut or a pounce pattern may be positioned as soon as at least two reference are available on an element, one permitting positioning in the X axis of the airplane and the other permitting positioning in the Z axis of the airplane. In practice, positioning from left to right and from top to bottom makes it possible to position all of the components one after the other without difficulty, using the references traced on each of the precuts or pounce patterns as control means. This makes it possible to overcome positioning tolerances and if necessary to distribute them between each of the elements. It is therefore not necessary to resort to particular tools to achieve positioning of these precuts or pounce patterns. FIG. 8 illustrates the positioning of precuts formed from developable surfaces, comprising characteristic points for their positioning. The developable surfaces presented in FIG. 8 are positioned and comprise the projection of two-dimensional patterns permitting them to be transferred onto the three-dimensional object.

Naturally, to satisfy specific needs, a person complement in the field of the invention will be able to apply modifications in the foregoing description.

1. A method for modeling precuts or pounce patterns for at least part of a three-dimensional object with a non-developable surface from a modeling of the said three-dimensional object, this method comprising:
breaking down the said at least one part of the said three-dimensional object into a plurality of surfaces; and
for each surface of the said plurality of surfaces, approximating the said surface of the said modeling of the said three-dimensional object by a developable surface.

2. The method according to claim 1, wherein it additionally comprises a step of measuring at least one error between at least one of the said developable surfaces of the said three-dimensional object and the said model of the said three-dimensional object, and in that the breaking down the said at least one part of the said three-dimensional object into a plurality of surfaces and of approximating the said surfaces of the said modeling of the said three-dimensional object by the said developable surfaces are repeated if the said at least one measured error is larger than a predetermined threshold.

3. The method according to claim 1, wherein the said modeling of the said three-dimensional object is an approximate modeling of the said three-dimensional object.

4. The method according to claim 1, wherein approximating a surface of the said part of the said modeling of the said three-dimensional object by a developable surface comprises determining a first and a second reference curve on the said modeling of the said three-dimensional object, the said developable surface being the constrained surface determined by the said first and second reference curves.

5. The method according to claim 4, wherein at least one of the said first and second reference curves is obtained by the intersection of a surface of the said modeling of the said three-dimensional object with a predetermined plane, or by a characteristic of a two-dimensional pattern to be projected onto the said three-dimensional object.

6. The method according to claim 4, wherein the said first and second reference curves are parallel.

7. The method according to claim 1, wherein it additionally comprises transferring at least one characteristic point of the said modeling of the said three-dimensional object onto at least one of the said developable surfaces.

8. A method for assisting in the transfer of a two-dimensional pattern onto a three-dimensional object with a non-developable surface, from a modeling of the said three-dimensional object and a projection of the said two-dimensional pattern onto the said modeling of the said three-dimensional object, this method comprising:
modeling precuts or pounce patterns for at least one part of the said modeling of the said three-dimensional object by a plurality of developable surfaces according to the method of claim 1; and
transferring at least part of the said projection of the said two-dimensional pattern onto at least one of the said developable surfaces, the said at least one of the said developable surfaces being adapted to be positioned on the said three-dimensional object in order to transfer at least part of the said two-dimensional pattern onto the said three-dimensional object.

9. A device comprising means adapted to employ each of the steps of the method according to claim 1.

10. A computer program comprising instructions adapted to employ each of the steps of the method according to claim 1.
